(19) United States
(12) Patent Application Publication
(10) Pub. No.: US 2011/0069958 A1
(43) Pub. Date: Mar. 24, 2011

(54) OPTICAL FREE SPACE DATA TRANSMISSION

(75) Inventors: Harald Haas, Edinburgh (GB); Erhard Bassow, Buxtehude (DE); Hany Elgala, Bremen (DE); Raed Mesleh, Tabuk (SA)

(73) Assignee: AIRBUS OPERATIONS GMBH, Hamburg (DE)

(21) Appl. No.: 12/990,263

(22) PCT Filed: Mar. 3, 2009
(86) PCT No.: PCT/EP2009/052514

§ 371 Date: Dec. 7, 2010

Related U.S. Application Data
(60) Provisional application No. 61/125,788, filed on Apr. 29, 2008.

(51) Int. Cl. H04J 14/00; H04B 10/00

(52) U.S. Cl. 398/77; 398/153; 398/140

(57) ABSTRACT

The invention relates to an aircraft data communication system as well as an aircraft comprising such a data communication system, in particular a wireless optical communication system inside an aircraft cabin and outside for aircraft services. The aircraft data communication system comprises a first sending unit 10 comprising a first sender and a first modulator, and a first receiving unit comprising a first receiver and a first demodulator. The communication system is adapted for a signal transmission between the first sender and the first receiver, wherein the signal transmission between the first sending unit and the first receiving unit is effected by light, and wherein the first modulator is adapted for modulating an amplitude of the transmitted light.

### REFERENCE TO RELATED APPLICATIONS

This application claims the benefit of the filing date of U.S. Provisional Patent Application No. 61/125,788 filed Apr. 29, 2008, the disclosure of which application is hereby incorporated herein by reference.

### FIELD OF INVENTION

The invention relates to an aircraft data communication system as well as an aircraft comprising such a data communication system, in particular a wireless optical communication system inside an aircraft cabin and outside for aircraft services.

### TECHNOLOGICAL BACKGROUND

Presently the data communication inside an aircraft cabin and for outside aircraft services is mainly based on wired signal guidance or on wireless radio frequency (RF) signal transmission. The wired signal transmission is less flexible regarding aircraft cabin (re-) configuration, short time customer requests and lead-time with respect to additional weight, costs and design effort in comparison to an aircraft with standard equipment. The signal transmission within an aircraft cabin that is based on wireless RF technologies may generate additional electromagnetic interference (EMI) load and strain for health of passengers and crew members.

Thus, instead of wireless radio frequency signal transmission, light may be used for data transmission. Coherent light faces the problems of high directionality and low spatial coverage, eye-safety issues and high costs which can be avoided by non-coherent light. Non-coherent light sources by nature disallow the use of phase information for data modulation (i.e. complex valued signals cannot be transmitted directly). It is, thus, only possible to encode the information into the amplitude of a signal. This electrical amplitude signal is converted into an optical power signal by a light emitting diode (LED) which results in an intensity modulation.

### SUMMARY OF INVENTION

There may be a need to provide an aircraft communication system which allows a simple reconfiguration without EMI.

According to a first aspect of the present invention, a wireless aircraft data communication system comprises a first sending unit comprising a first sender and a first modulator, and a first receiving unit comprising a first receiver and a first demodulator. Therein the communication system is adapted for a signal transmission between the first sender and the first receiver, wherein the signal transmission between the first sending unit and the first receiving unit is effected by light, and wherein the first modulator is adapted for modulating an amplitude of the transmitted light.

In other words, the invention according to the first aspect of the invention may be seen as the basis of the idea to provide a wireless aircraft data communication system which is adapted to transmit data from a sender to a receiver, wherein the transmission medium is light. Therein, before signal transmission, the data is modulated using a modulator so that the information of the data may be comprised in the modulated amplitude of the light.

The data communication system according to the invention may be used for optical wireless data transmission within aircraft, e.g. for aircraft in-flight entertainment (IFE) systems and for service and maintenance support. Further, the data communicating system can be used for individual communication within an aircraft cabin. The system may be used insight and outsight of aircraft cabins.

In the following, possible details, features and advantages of the wireless aircraft data communication according to the first aspect of the invention will be explained in detail.

The term “first sending unit” may signify e.g. an optical access point (OAP). The term first receiving unit may signify e.g. an optical terminal or an optical transceiver (OT).

The data transmission technique according to the present invention may enable high data rate digital data transmission via e.g. light sources and/or optical apertures over longer distances. In other words, the achievable data rates and transmission ranges may be independent of modulation technology.

The technology may be used in optical wireless access points, and fixed as well as mobile receivers mounted in components within aircraft cabin like for example passenger service units (PSU), flight attendant panels (FAP), illumination ballast units (IBU), etc.

The technique of the communication system according to the invention may be the basic of optical wireless data communication inside and outside aircraft cabin for transmission of e.g. audio and/or video content for e.g. passenger information, cabin video monitoring (CVM) and in-flight entertainment; device control and monitoring, i.e. passenger service unit, cabin illumination modules, signs and sensors, flight attendant panel, crew intercom, CVM cameras, etc.; signal transmission for aircraft service staff and their devices; data transmission of sensor sub-networks; and device status submission for maintenance support, status of cargo load and other equipment, etc.

Based on the technology of the communication system according to the invention, the optical wireless data transmission may substitute the signal wiring of “the last end” between the electronic devices and the backbone busses of the cabin management system like e.g. cabin intercommunication data system (CIDS).

The communication system according to the invention may effect e.g. an increase of flexibility of cabin (re-)configuration and design; reduce e.g. lead-time of special or short time customer requests; reduce e.g. expenditure for addressing and system test within final assembly line (FAL); reduce e.g. weight and cost reduction per ship set.

Moreover, the wireless optical data transmission system may not generate radio frequency (RF) power within aircraft cabin and in following no additional electro magnetic interference load and strain for health.

According to an embodiment of the present invention, the light is non-coherent light.

There are basically two types of light sources: coherent light, i.e., laser light and non-coherent light. In the present invention, non-coherent light may be used for data transmission. Non-coherent light may be light wherein the light waves have no fixed, but a variable phase relation to each other. Non-coherent light sources are cheap, easy to handle and there may be no risk of eye damages.

According to an embodiment of the present invention, the light is an infrared light.

Infrared light may neither interfere with other communications signals nor may it be affected by other signals. Moreover, infrared light may be easy to handle. Infrared light is not visible which means that it may not disturb or irritate the optical sense of passengers, personnel, etc.

According to an embodiment of the present invention, the light is infrared light in the range of 780 nm to 2500 nm, in particular between 900 nm and 1100 nm.

Infrared radiation has wavelengths between about 750 nm and 2500 nm. In the invention, the range between 900 nm and 1100 nm may be of relevance. This range has a sufficient distance to the range of visible light which means that infrared light in that preferred range may not be registered by human organisms.

The wireless optical data transmission inside and outside the aircraft may be based on the principle of diffuse free space signal propagation. Investigations within aircraft cabin have shown that the free space signal propagation may be influenced by various factors like aircraft cabin geometry including things, topics and equipment inside cabin, material and surface consistence of cabin parts and equipment, the optical wavelength which is chosen for signal transmission within the near infrared frequency range (NIR), the number of people who are sitting in an optical cell or which are moving through as well as their clothing including its material.

The investigations have also shown that there is an optimum spectral range for wireless signal propagation within aircraft cabin between 900 nm and 1100 nm. This spectral range may be preferred for use, because the spectral range between 900 nm and 1100 nm shall be licensed and protected for use for optical data transmission inside and outside the aircraft by means of free space signal propagation. The shorter wavelength at the proposed range allows a higher data transfer rate.

According to an embodiment of the present invention, the first sending unit comprises a light source, wherein the light source is capable of amplitude-modulating by using a digital modulation technique.

In the present invention, it may be useful to encode information that should be transmitted into the amplitude of a signal. This electrical amplitude signal may be converted into an optical signal, e.g. by a light emitting diode (LED).

According to an embodiment of the present invention, the digital modulation technique is at least one modulation technique out of a group, the group consisting of quadrature amplitude modulation (QAM) and pulse amplitude modulation (PAM), and both modulation types in combination with multiple access technologies.

The present invention proposes a technique that may allow the transmission of complex valued signals using e.g. optical non-coherent light sources. This means that higher order modulation techniques such as QAM may be applied. As a result it may be possible to transmit not only one bit per sample period, but several bits depending on the actual channel condition which enables much higher spectral efficiencies. As a consequence, the disadvantage of low spectral efficiencies may be significantly mitigated, as it may be possible to use powerful link adaptation techniques.

The data transmission technique according to the present invention may be insensible to multipath propagation. This means that the effect of signals that are impinging at different delayed time instances may not affect the detection of the transmitted data signal.

The data transmission technique according to the present invention may enable the use of multiple access techniques such as e.g. time division multiple access (TDMA), frequency division multiple access (FDMA), code division multiple access (CDMA), space division multiple access (SDMA) and carrier sense multiple access (CSMA).

In fact, it is very difficult, or even impossible to apply these multiple access techniques to conventional state-of-the-art “pulse modulation techniques”. However with this invention, it is possible to apply multi-user access techniques to the transmission signal used for data modulation of non-coherent light sources.

According to an embodiment of the present invention, the first sending unit comprises a second receiver, and the first receiving unit comprises a second sender, wherein the signal transmission is a bidirectional transmission (duplex transmission) between the first sender and the first receiver, and the second sender and the second receiver.

By using a first sending unit comprising a second receiver and a first receiving unit comprising a second sender, it may be possible to transmit data bi-directionally, i.e. from the first sending unit towards the first receiving unit, and from the first receiving unit to the first sending unit.

According to an embodiment of the present invention, the communication system comprises a plurality of receiving units.

The communication system may comprise more than one receiving unit, i.e. data may be transmitted from a first sending unit to more than one, i.e. the first receiving unit.

According to an embodiment of the present invention, at least one receiving unit is adapted to operate as a repeater for forwarding a signal transmission between a further receiving unit and the first sending unit.

A receiving unit may detect data sent out by another sending unit or receiving unit and convey the data to another receiving unit or a sending unit. Alternatively, a receiving unit may detect data sent out by the first sending unit and convey the data to another receiving unit.

According to an embodiment of the present invention, the wireless aircraft data communication system further comprises a second sending unit, wherein a part of the plurality of receiving units is allocated to the first sending unit and a second part of the plurality of receiving units is allocated to the second sending unit.

According to an embodiment of the present invention, the communication system is adapted to carry out a handover of a receiving unit from the first sending unit to the second sending unit.

Adaptive radio resource allocation techniques may be applied. As a result, the new transmission technology may allow for the establishment of e.g. an optical wireless cellular network, which may be characterized by point-to-multi-point as well as multi-point-to-point transmission structures. Hence, this technique may be optimized for multi-user communication in multi-cell topology in an indoor and/or outdoor environment, which is changing dynamically.

The smallest resource unit, which may be assigned to a “user” or user groups may be a “chunk”, whereby a “chunk” can be a single subcarrier or multiple subcarriers. “Users” may be electronic devices, which may be authorized for data communication. Each “chunk” may be determined in base band by sub-carrier frequency, time slot and its duration. Other chunk characteristics may be the modulation scheme and the coding type which can be changed in dependence of link quality to each user respectively user group.

All units (authorized devices) may be a part of a dynamically organized wireless optical network, which may be operated inside and outside the aircraft cabin. Both the chunks and the optical spectral lines of a network cell can be re-used in other supply areas of the wireless optical network. The supply areas (optical cells) may overlap each other if redundancy is requested.

According to a second aspect of the invention, an aircraft comprises a wireless data communication system according to the invention, wherein the first sending unit is connected to a control unit of an aircraft, and wherein the aircraft has distributedly mounted a plurality of receiving units.

The control unit may control the data transmission from and to the sending and receiving units and, if necessary, effect further processes, e.g. controlling alarms, signs, cameras, etc.

According to an embodiment of the second aspect of the present invention, the receiving unit is mounted onto a passenger seat.

According to an embodiment of the second aspect of the present invention, the sending unit is mounted onto a cabin panel element or passenger service unit.

The aspects defined above and further aspects, features and advantages of the present invention can also be derived from the examples of embodiments to be described hereinafter and are explained with reference to examples of embodiments. The invention will be described in more detail hereinafter with reference to examples.

### BRIEF DESCRIPTION OF THE DRAWINGS

FIG. 1 shows a schematic representation of a side view illustrating the supply area for optical wireless data transmission between first sending unit and passenger service unit according to an embodiment of the invention.

FIG. 2 shows a schematic representation of a front view illustrating the supply area for optical wireless data transmission between first sending unit and passenger service unit according to an embodiment of the invention.

FIG. 3 shows a schematic representation of a front view illustrating the redundancy of first sending unit links according to an embodiment of the invention.

FIG. 4 shows a schematic representation of a front view illustrating the supply area for optical wireless data transmission between first sending units and cabin illumination modules according to an embodiment of the invention.

FIG. 5 shows a schematic representation of a front view illustrating the supply area for optical wireless data transmission between first sending units and crew intercom devices or/and headphones for crew intercommunication according to an embodiment of the invention.

FIG. 6 shows a schematic representation of a front view illustrating the supply area for optical wireless data transmission between first sending units and optional mini flight attendant panel according to an embodiment of the invention.

FIG. 7 shows a schematic representation of a front view illustrating the supply area for optical wireless data transmission between first sending units and in-flight entertainment receivers (e.g. first receiving unit) on the upper side of passenger chairs (direct path) according to an embodiment of the invention.

FIG. 8 shows a schematic representation of a front view illustrating the supply area for optical wireless data transmission between passenger service units used as support points and in-flight entertainment receivers (e.g. first receiving unit) on the upper side of passengers chairs (secondary path) according to an embodiment of the invention.

FIG. 9 shows a schematic representation of a front view illustrating the supply area for optical wireless data transmission between moveable maintenance service computer, which is equipped with a first sending unit, and the devices under test each provided with a first receiving unit according to an embodiment of the invention.

FIG. 10 shows a schematic representation of a front view illustrating the supply area for optical wireless data transmission outside aircraft and inside the cargo bay for tracking of cargo containers and payloads which are equipped with first receiving units according to an embodiment of the invention.

FIG. 11 shows a schematic representation of a first front view illustrating the supply area for optical wireless data transmission between a first sending unit and signs, sensors and cameras according to an embodiment of the invention.

FIG. 12 shows a schematic representation of a second front view illustrating the supply area for optical wireless data transmission between a first sending unit and signs, sensors and cameras according to an embodiment of the invention.

FIG. 13 shows a schematic representation of a front view of an aircraft illustrating the supply area for optical wireless data transmission outside aircraft on ground operation according to an embodiment of the invention.

FIG. 14 shows a schematic representation of a side view of an aircraft illustrating the supply area for optical wireless data transmission outside aircraft on ground operation according to an embodiment of the invention.

FIG. 15 shows a schematic representation of the signal processing according to the invention.

FIG. 16 shows a block diagram of the communication system according to the invention.

The illustration in the drawings is schematically only and not scale. It is noted in different figures, similar elements are provided with the same reference signs.

### DETAILED DESCRIPTION OF EXEMPLARY EMBODIMENT

In the following, the term “optical access point (OAP)” may correspond to the term “first sending unit”, an OAP may further comprise a second receiver. There may exist a plurality of OAPs. The term “optical terminal/transceiver (OT)” may correspond to the term “first receiving unit”, an OT may comprise a second sender unit. There may exist a plurality of OTs.

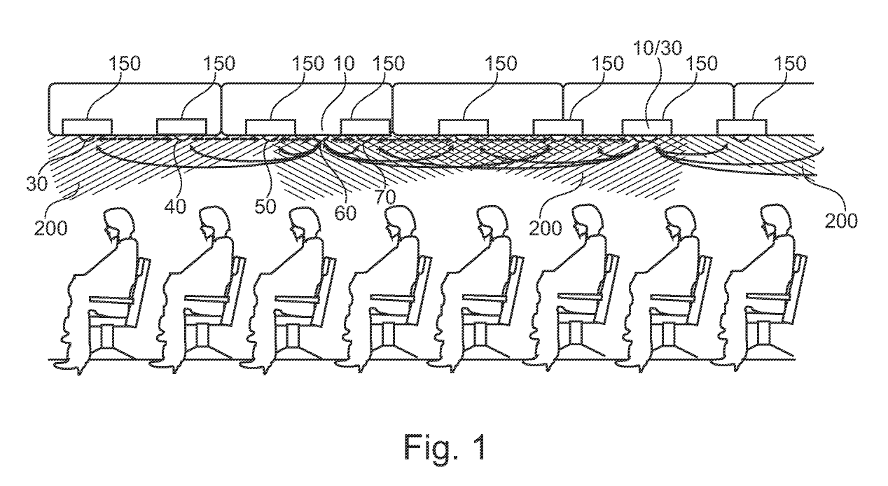

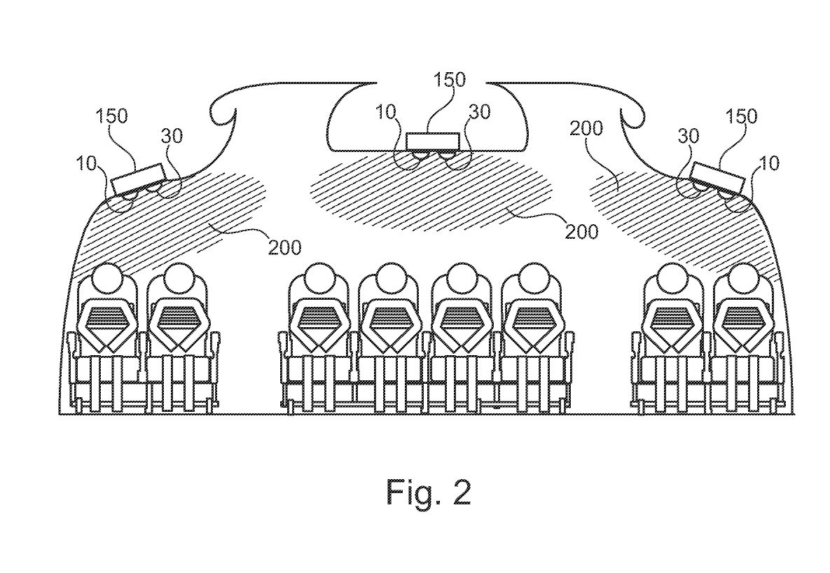

FIGS. 1 and 2 show a schematic representation of a side and front view illustrating the supply area for optical wireless data transmission between first sending unit and passenger service unit according to an embodiment of the invention.

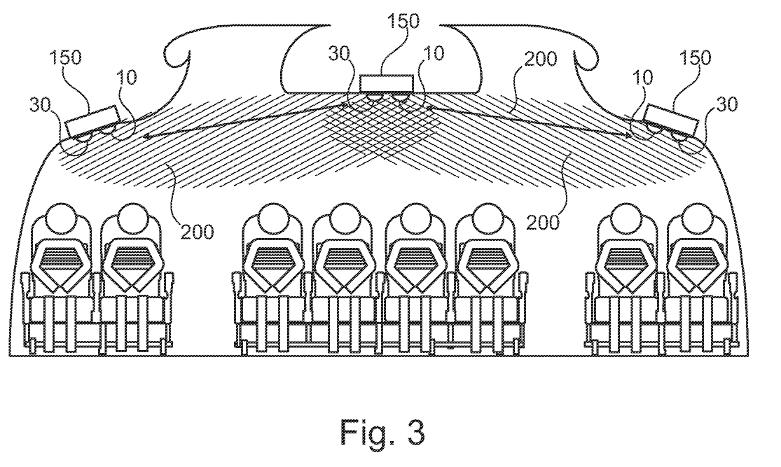

FIG. 1 up to FIG. 3 illustrates the use case “control, monitor and broadcast PSU”. The command and monitor data of passenger service unit (PSU) 150 as well as broadcast information are transmitted optically and wireless between OAPs 10 and OT 30, 40, 50, 60, 70 within their supply area (optical cell). For that reason each PSU 150 is equipped with an OT 30, 40, 50, 60, 70.

200 illustrates the diffuse propagation of optical signals between OAPs 10 and OTs 30, 40, 50, 60, 70, wherein the continuous arrow line illustrates the nominal transmission route of signals, and the broken arrow line illustrates the stand-by transmission route.

The wireless optical network may follow a cellular structure with OAPs 10 in the center. The wireless optical network may consists of at least one cell including one OAP 10 and one or more OTs 30, 40, 50, 60, 70 minimum. The supply areas (optical cells) may overlap each other if redundancy is required. The overlapping cell structure is the default scenario, which is applied for aircraft applications.

An optical transceiver 40 may convey information from an optical transceiver 30 to another optical transceiver 50.

Generally, the OAPs 10 can be located near the PSUs 150 or on a PSU each in dependence of transmitting and receiving conditions of the diffuse optical signal propagation.

FIG. 3 shows a schematic representation of a front view illustrating the redundancy of OAP links according to an embodiment of the invention.

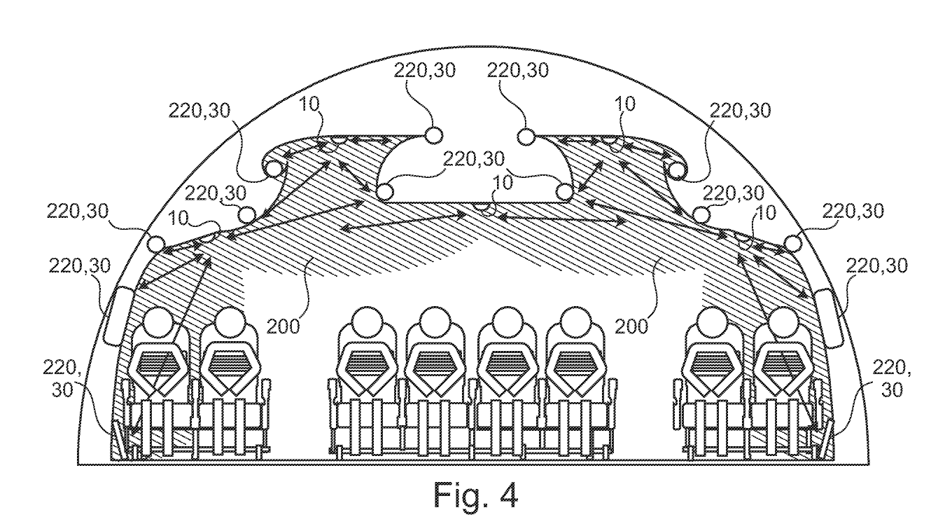

FIG. 4 shows a schematic representation of a front view illustrating the supply area for optical wireless data transmission between first sending units 10 and cabin illumination modules 220 according to an embodiment of the invention.

The controlling and monitoring of cabin illumination modules 220 is based on the “wireless optical PSU network”. The principle may be comparable to use case 1 (FIGS. 1 to 3) or identical with it. OAPs 30, optionally in combination with light modules 220, may be added on the ceiling or other sites if necessary.

Cabin illumination modules 220 may be LED stripes respectively LED modules, fluorescent lamps or other lamps for cabin illumination.

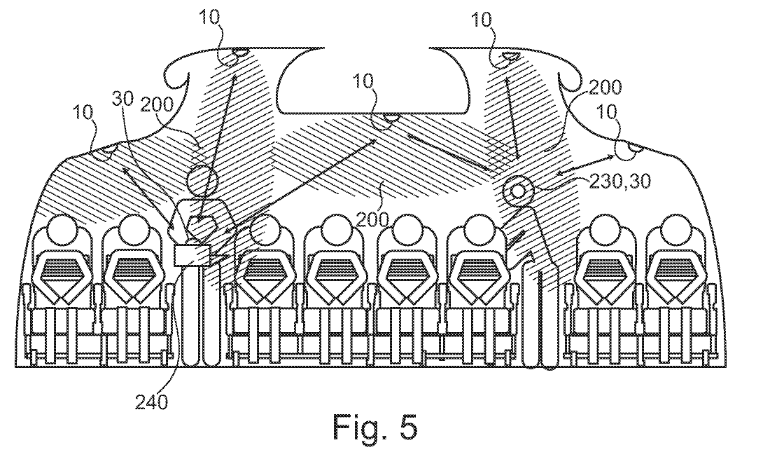

FIG. 5 shows a schematic representation of a front view illustrating the supply area for optical wireless data transmission between first sending units 10 and crew intercom devices or/and headphones 230, 240 for crew intercommunication according to an embodiment of the invention.

Crew intercommunication within aircraft cabin may be also based on the wireless optical cabin network or parts of it. This network may be comparable with respectively identical to the “wireless optical PSU network” of use case 1 (FIGS. 1 to 3) added by OAPs 10 on the ceiling or other sites if necessary (use case 2).

The crew devices 230, 240 are special equipped with OTs 30 for wireless optical intercommunication. The crew communication devices like e.g. Pocket PCs or Mini-PCs 240 as well as crew headsets 230 communicate with a suitable OAP 10. If crew communication devices and headsets 230, 240 are moved, they may be roamed by the network from OAP to OAP on the moving way through the cabin.

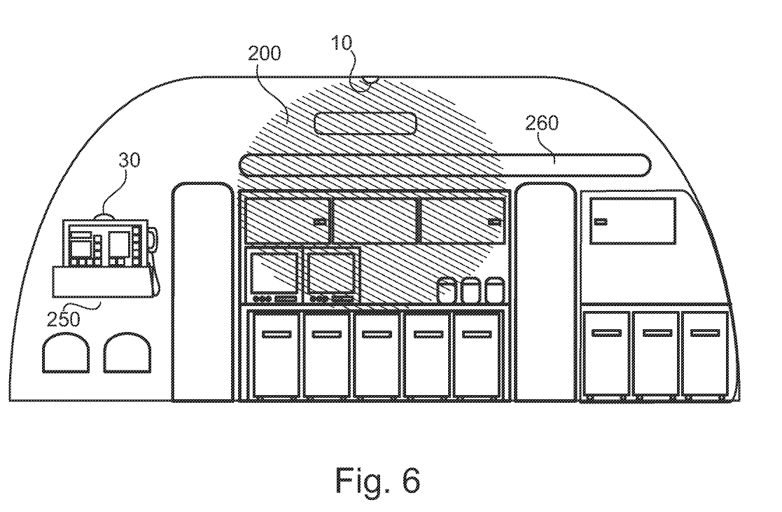

FIG. 6 shows a schematic representation of a front view illustrating the supply area for optical wireless data transmission between first sending units 10 and optional mini flight attendant panel (Mini-FAP) 250 according to an embodiment of the invention.

The Mini-FAP 250 is equipped with an OT 30. This FAP is allocated within the supply area of an OAP 10. The mounting site of the OAP 10 can differ from the depicted one depending on a cabin geometry and material as well as the selected optical wavelength within the optical cell.

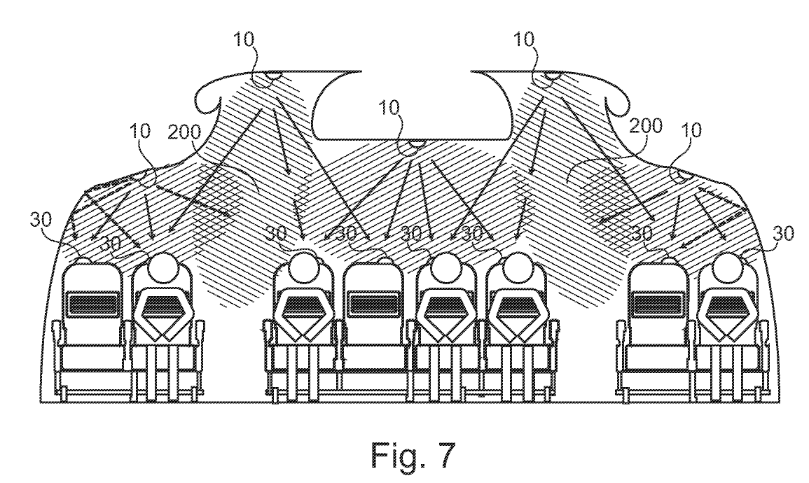

FIG. 7 shows a schematic representation of a front view illustrating the supply area for optical wireless data transmission between first sending units 10 and in-flight entertainment receivers (e.g. a first receiving unit) 30 on the upper side of passenger chairs (direct path) according to an embodiment of the invention.

Devices and monitors for passenger entertainment can be located on various sites inside the aircraft cabin. This equipment can be located for example below the PSU 150 channel above passenger heads or in the backrest of passenger chairs. In any case the in-flight entertainment content can be transmitted optically and wireless.

Each or a plurality of passenger seats is equipped with an OT 30, which is located in the upper part of the backrest. The OTs receive the IFE content from a suitable OAP 10 which is accommodated on a suitable site for example in PSUs, in the PSU channel or nearby as well as on the ceiling. The final OAP 10 mounting sites can differ from the depicted ones depending on a cabin geometry and material as well as the selected optical wavelength within the optical cell.

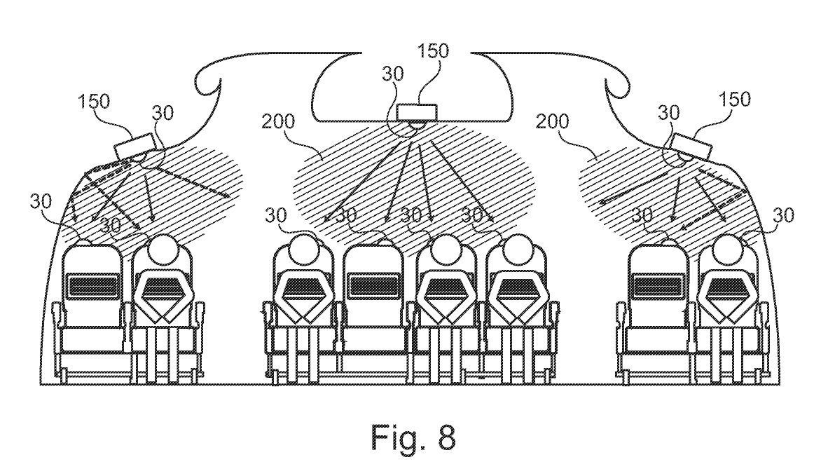

FIG. 8 shows a schematic representation of a front view illustrating an alternative scenario for IFE data transmission between PSU 10 and OT 30 in the backrest of PAX seats. It shows the supply area for optical wireless data transmission between passenger service units 150 used as support points and in-flight entertainment receivers (e.g. first receiving unit) 30 on the upper side of passengers chairs (secondary path) according to an embodiment of the invention.

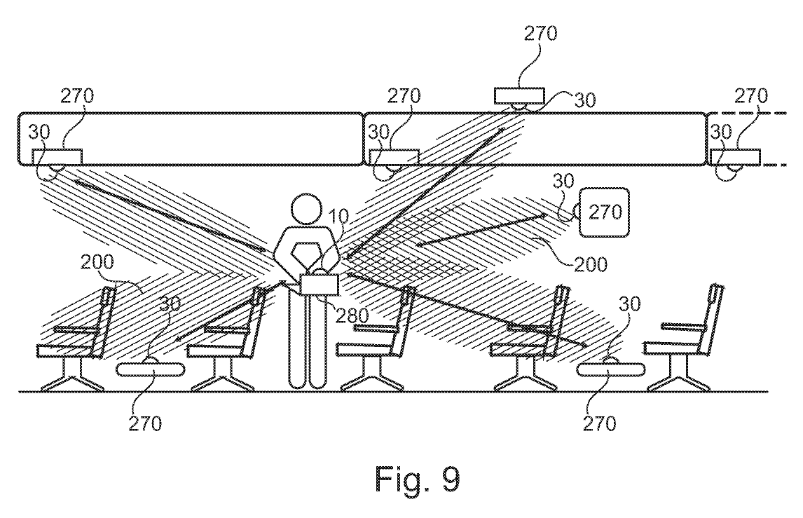

FIG. 9 shows a schematic representation of a front view illustrating the supply area for optical wireless data transmission between moveable maintenance service computer (MSC) 280 which is equipped with a first sending unit 10 and the devices under test 270 each provided with a first receiving unit 30 according to an embodiment of the invention.

Therein, the wireless optical data transmission may offer the possibility to identify, control and monitor devices 270 or sub systems independently from the cabin network. This feature can be used for equipment check, status indication, to ease maintenance or for special services.

For that purpose a MSC 280 is equipped with an OAP 10. Service personnel can communicate optically and wireless with devices 270 or sub systems inside and outside the aircraft using this MSC. Preconditions for this “mobile” kind of identification, status monitoring and controlling of equipment are: a) the MSC/OAP 280, 10 which is used by the staff must be authorized to contact a special device or system, b) the MSC-OAP 280, 10 has to be operated near the equipment which shall be contacted or supervised, i.e. the device has to be in range of the moveable OAP 10.

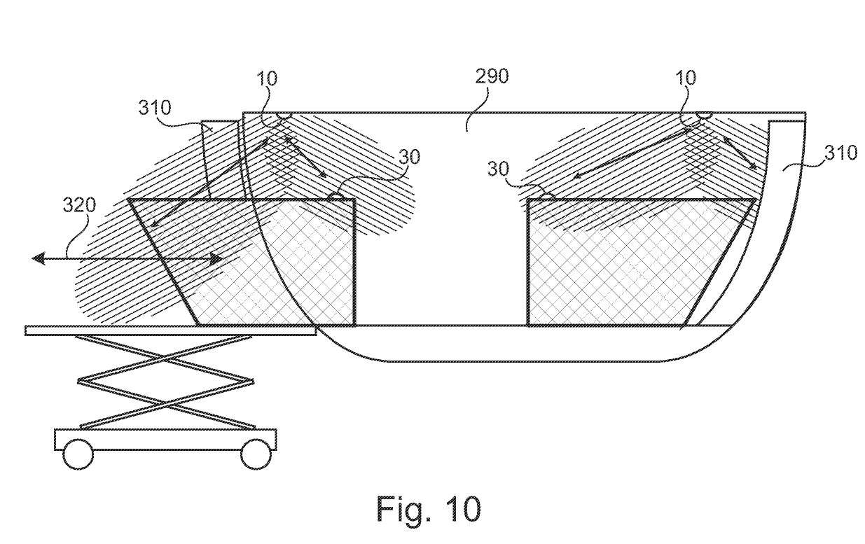

FIG. 10 shows a schematic representation of a front view illustrating the supply area for optical wireless data transmission outside aircraft and inside the cargo bay 290 for tracking of cargo containers and payloads which are equipped with first receiving units 30 according to an embodiment of the invention.

The wireless optical data transmission using the principle of diffuse light propagation between a stationary OAP 10 and moveable OTs 30 may be used during the un-/loading 320 of freight and load identification. For that reason an OAP 10 is mounted in the range of or near the door 310 to cargo bay 290 and freight compartment, respectively. OTs 30 are located on freight containers or cargo. In this way it may be possible to identify which freight containers or cargo are un-/loaded or are to be un-/loaded.

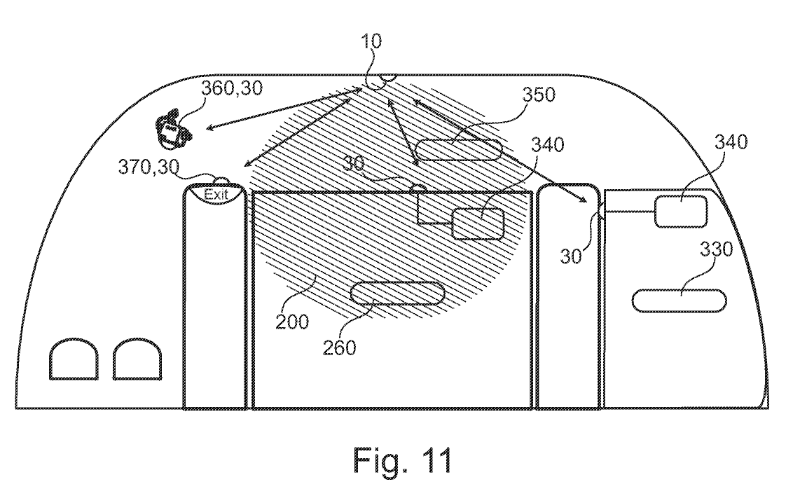

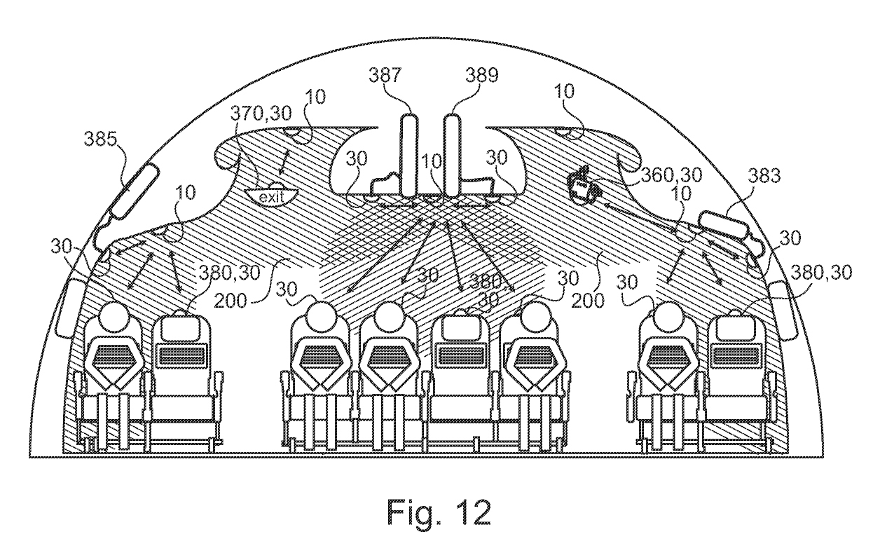

FIGS. 11 and 12 show a schematic representation of a first and second front view illustrating the supply area for optical wireless data transmission between a first sending unit 10 and signs, sensors and cameras 360 according to an embodiment of the invention. Signs may be general signs (e.g. exit sign) 370, smoke warning signs 350, etc. Sensors may be e.g. smoke sensors 340, general sensors 380, noise sensors 383, vibration sensors 385, temperature sensors 387, humidity sensors 389, etc.

Signs, sensors and equipment for cabin security can be installed at various sites within the aircraft. They can be located within the passenger cabin, monuments like lavatory 330, inside the galley 260 or cargo bay 290, etc.

In order to transmit the data, the optical wireless cabin network can be used. Separate network parts or local “mini-networks” are also possible. They may include an OAP 10 and one or more OTs 30 mounted on signs, sensors or cameras.

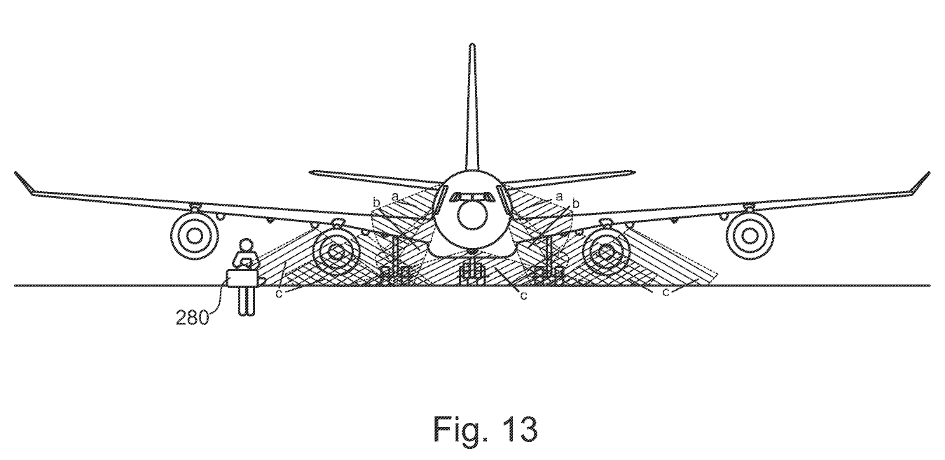

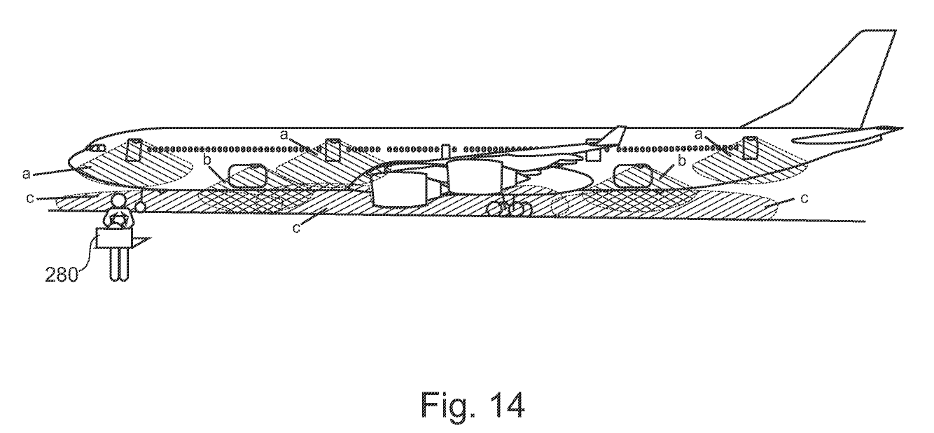

FIGS. 13 and 14 show a schematic representation of a front and side view of an aircraft illustrating the supply area for optical wireless data transmission outside aircraft on ground operation, e.g. outside aircraft maintenance support, services, supervision and security, according to an embodiment of the invention.

For that purpose a MSC 280 is equipped with an OAP 10. Service personnel can communicate optically and wireless with devices or sub systems inside and outside the aircraft using this MSC. Preconditions for this “mobile” kind of identification, status monitoring and controlling of equipment are: a) the MSC/OAP 280, 10 which is used by the staff must be authorized to contact a special device or system, b) the MSC-OAP 280, 10 has to be operated near the equipment which shall be contacted or supervised, i.e. the device has to be in range of the moveable OAP 10.

The principle of diffuse optical signal propagation 200 in free space may be applied for outside data transmission in the immediate environment of aircraft. For that purpose OAPs 10 are located at reasonable sites outside aircraft. Security staff, maintenance and service personnel can use these optical cells for their work on ground around the aircraft. Precondition is that the personnel respectively their equipment are announced in the cabin network. The limited range of diffuse optical free-space transmission is particular beneficial here since it avoids interference between neighboring airplanes being serviced by different staff. Moreover, ground staff must be authorized for operation within the network.

The third condition is that headphones, cameras, MSCs 280 and other devices intended for use with the inventive system must be equipped with an OT 30 so that these OTs 30 can communicate optical wireless with suitable OAPs 10. If staff moves the position and leave the actual supply area the devices are roamed by the network.

In the figures, “a” signifies data transmission from inside cabin to outside use on ground, “b” signifies data transmission from inside cargo bay to outside aircraft use on ground, and “c” signifies data transmission from outside allocated wireless access points 10 for outside aircraft use on ground.

The final OAP 10 mounting sites can vary from the depicted ones depending on a geometry, material outside aircraft as well as the selected optical wavelength, which is used in practice outside the aircraft.

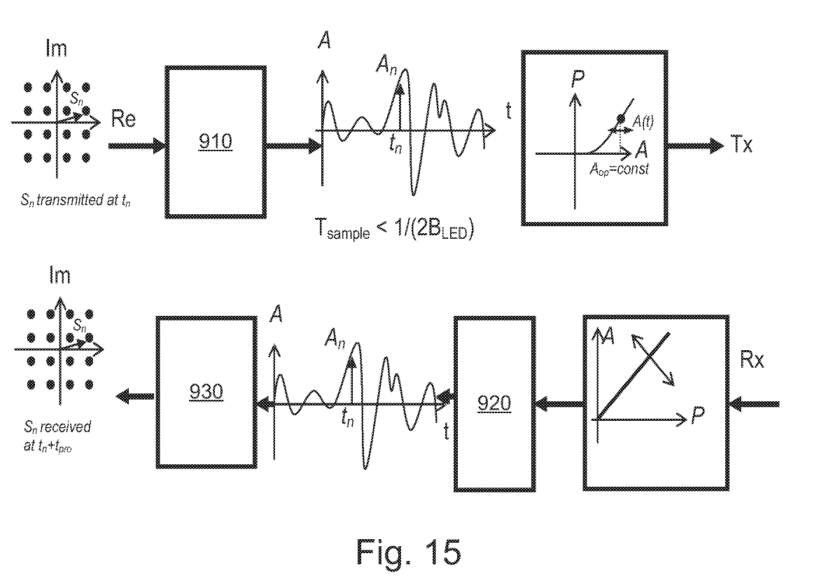

FIG. 15 shows a schematic representation of the signal processing according to the invention.

Intensity modulation/direct detection (IM/DD) link differs from conventional systems because the channel input represents instantaneous optical power; the channel input is non-negative. Accordingly, a DC component must be added to the signal for this exemplary embodiment.

Conventional techniques use positive pulses and exploit their properties. Pulses can either be analogous which means that some attribute of the pulse varies continuously in a one-to-one correspondence with a sample value, or digital, in which some attribute of a pulse takes on a certain values from a set of allowable values.

Typical representatives are pulse position modulation (PPM), pulse width modulation (PWM) and on-off keying (OOK). The optical wireless standard, infrared data association (IrDA), for example, used PPM. The main problem of those techniques may arise from two facts: (a) the poor spectral efficiency of these techniques, and (b) the vulnerability to multipath propagation. Multipath propagation causes inter-symbol interference, which renders the correct detection of the transmitted information signal practically impossible.

This means, that only relatively low transmission rates at very short distances are possible. To communicate via IrDA, devices must have a direct line of sight. For example, with currently available IrDA equipment one can transmit exemplarily up to 4 Mbps at a few meters.

The technology may be used in optical wireless access points, and fixed as well as mobile receivers mounted in components within aircraft cabin like for example passenger service units, flight attendant panels, illumination ballast units, etc.

Digital modulation techniques such as quadrature amplitude modulation (QAM) may be applied to modulate non-coherent light sources. As a consequence, the system needs to convey complex symbols via a transmitter that only enables the transmission of a power signal. The signal processing using QAM technique according to the invention is illustrated in FIG. 1.

First a block of time discrete complex symbols, Sₙ, is transformed into a vector of real valued signals with amplitudes Aₙ. The complex-to-real transformer 910 ensures that the amplitude of the signal A is within some given limits, −Aₘᵢₙ≦A≦ₘₐₓ. The discrete time series is then converted into a mean-free and time-varying analogue signal, which is band-limited by B_{LED}.

For example, with a LED that has a 3-dB corner frequency (B_{LED}) of 25 MHz, it is possible to transmit with 100 Mbps using 16 QAM modulation. The analogue AC signal drives the LED about an operational point, which requires the application of a DC offset. The operational point is to be selected such that Aₘᵢₙ and Aₘₐₓ is still in the linear region of the transfer characteristic of the LED.

The transmitted signal can be cyclically extended by at least the maximum delay of the channel. Thereby, the impact of multipath propagation can be eliminated by using appropriate equalization techniques.

At the receiver, the DC offset introduced by the transmitter and additional low frequency ambient noise is first removed 920 and an algorithm is applied, which changes the slope of the transimpedance amplifier load line dynamically. This variable feed back/gain resistance avoids amplifier saturation and provides a linear current-to-voltage transfer characteristic at the photo diode.

A synchronization algorithm is applied which ensures optimum sampling at the receiver during the A/D conversion. The received discrete samples are then fed into a real-to-complex transformer 930 and after channel equalization and detection the transmitted sequence of complex symbols (digital (higher order) modulation symbols) are obtained.

Different solutions for the complex-to-real 910 and real-to-complex transformer 930 realizations are possible. One solution is to exploit the properties of the Fourier transform, i.e., the fact that the Fourier transform of symbol vector x of size N and its conjugate complex representation, x*, results in an output vector of size 2N with only real elements.

Another solution is to use different wavelengths in the LED to modulate real and imaginary parts of the signal. A further possible solution is to use a multiple-input-multiple-output (MIMO) approach. The real and imaginary parts are transmitted by different, spatially separated LEDs. The 2×2 transmission channel is typically uncorrelated, especially in a rich-scattering environment so that the channel matrix is full rank, and, thus, the two data streams are separable.

The proposed transmission technology enables the use of adaptive link adaptation since it supports different higher order modulation schemes.

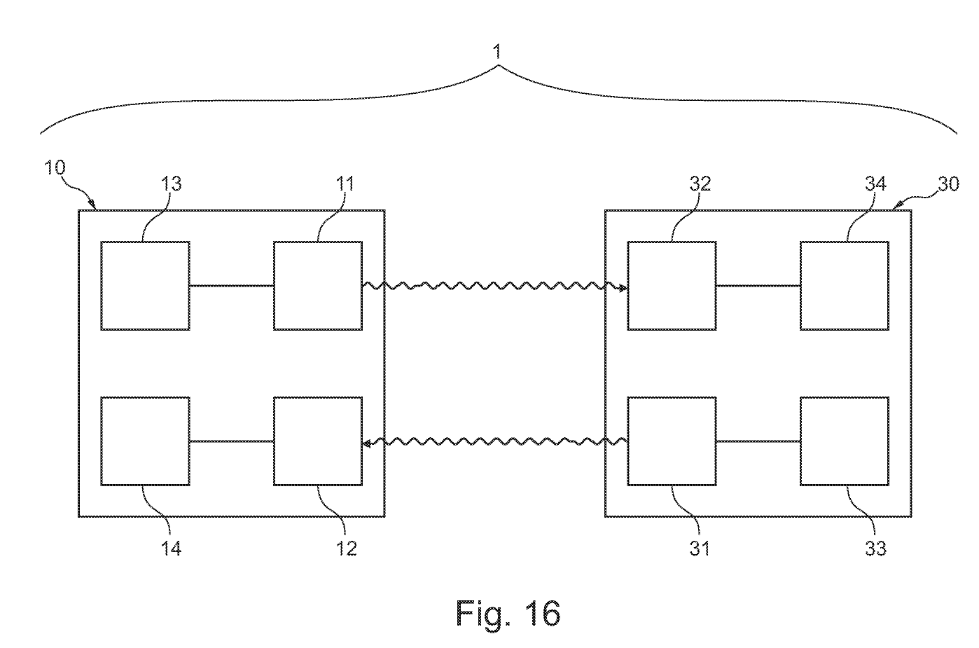

FIG. 16 shows a block diagram of the communication system according to the invention.

A wireless aircraft data communication system 1 according to the invention may comprise a first sending unit 10 comprising a first sender 11 and a first modulator 13. The system may further comprise a first receiving unit 30 comprising a first receiver 32 and a first demodulator 34. The communication system 1 is adapted for a signal transmission between the first sender 11 and the first receiver 32. The signal transmission between the first sending unit 10 and the first receiving unit 30 may be effected by light. The first modulator 13 is adapted for modulating the amplitude of the transmitted light.

The first sending unit 10 of the wireless aircraft data communication system 1 may further comprise a second receiver 12 and a second demodulator 14. The first receiving unit 30 may comprise a second sender 31 and a second modulator 33. The signal transmission may be a bi-directional transmission between the first sender 11 and the first receiver 32, and the second sender 31 and the second receiver 12.

The figures and use cases listed above are possible applications of wireless optical data transmission within aircraft cabin and outside the aircraft. They are based on the “Complex modulated signals with orthogonal frequency division multiplexing (CMS-OFDM) technique for intensity modulated non-coherent light sources”.

The character of optical signal propagation inside the cabin and outside aircraft may preferably be diffuse and not directed.

The figures show the positions of optical access points 10 and optical transceivers 30 only in principle but not in final position because of their final position depends on aircraft cabin geometry, material and surface consistence of cabin parts and equipment, the optical wavelength which is chosen for signal transmission within the near infrared frequency range (NIR), security and reliability issues.

Differences between the pictorial representation and the final position in practice may occur.

All figures only show the details, which are relevant to characterize each, considered use case and the optical signal propagation respectively. But it should be noticed that there is an optical wireless network, which covers the entire aircraft cabin, the cargo bay and other internal aircraft rooms and the external surroundings directly around the aircraft. This does not exclude that only parts of the wireless optical network or single applications/use cases are installed and operated.

The wireless optical network follows a cellular structure with optical access points in the center. The wireless optical network consists of at least one cell including one OAP and one or more OTs minimum. The supply areas (optical cells) could overlap each other if redundancy is requested. The overlapping cell structure is the default scenario, which is applied for aircraft applications.

Generally, the OAPs can be located near the passenger service units or on a passenger service unit each depending on transmitting and receiving conditions of the diffuse optical signal propagation.

The principle of diffuse light propagation may also be used in this scenario to make sure that the data transmission between OAP and Mini-FAP works despite the movement of and blocking by crew members or passengers who roam within these zones.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

### LIST OF REFERENCE SIGNS

1 communication system
10 first sending unit/optical access point
11 first sender
12 second receiver
13 first modulator
14 second demodulator
15 light source
20 second sending unit/optical access point
30 first receiving unit/optical terminal/optical transceiver
31 second sender
32 first receiver
33 second modulator
34 first demodulator
40 second receiving unit/optical terminal/optical transceiver
50 third receiving unit/optical terminal/optical transceiver
60 forth receiving unit/optical terminal/optical transceiver
70 fifth receiving unit/optical terminal/optical transceiver
100 aircraft
101 control unit
110 cabin panel element
130 passenger seat
140 passenger seat
150 passenger supply unit
200 diffuse propagation of optical signals
220 light module
230 head set
240 crew communication device
250 mini flight attendant panel
260 galley
270 device
280 maintenance service computer
290 cargo bay
310 cargo door
320 loading/unloading
330 lavatory
340 smoke sensor
350 smoke warning
360 camera
370 signs
380 sensor
383 noise sensor
385 vibration sensor
387 temperature sensor
389 humidity sensor
910 complex-to-real transformer
920 synchronization and DC offset removal
930 real-to-complex transformer
a from inside cabin to outside aircraft use on ground
b from inside cargo bay to outside aircraft use on ground
c from outside allocated wireless access points for outside aircraft use on ground

1. An aircraft data communication system, comprising:
a first sending unit comprising a first sender and a first modulator, and
a first receiving unit comprising a first receiver and a first demodulator,
wherein the aircraft data communication system is adapted for signal transmission between the first sender and the first receiver,
wherein the signal transmission between the first sending unit and the first receiving unit is effected by light,
wherein the first modulator is adapted for modulating an amplitude of the transmitted light, and
wherein the aircraft data communication system is a wireless aircraft data communication system.

2. The aircraft data communication system according to claim 1, wherein the light is non-coherent light.

3. The aircraft data communication system according to claim 1, wherein the light is an infrared light.

4. The aircraft data communication system according to claim 3, wherein the infrared light is in the range of 780 nm to 1 mm.

5. The aircraft data communication system according to claim 1, wherein the first sending unit comprises a light source, wherein the light source is capable of amplitude-modulating by using a digital modulation technique.

6. The aircraft data communication system according to claim 5, wherein the digital modulation technique is selected from the group consisting of
quadrature amplitude modulation,
pulse amplitude modulation
wherein a multiple access technique is selected the group consisting of
time division multiple access,
frequency division multiple access,
code division multiple access,
space division multiple access, and
carrier sense multiple access

7. The aircraft data communication system according to claim 1,
wherein the first sending unit comprises a second receiver, and
the first receiving unit comprises a second sender,
wherein the signal transmission is a bidirectional transmission between the first sender and the first receiver, and the second sender and the second receiver.

8. The aircraft data communication system according to claim 1,
wherein the aircraft data communication system comprises a plurality of receiving units.

9. The aircraft data communication system according to claim 1,
wherein at least one receiving unit is adapted to operate as a repeater for forwarding a signal transmission between a further receiving unit and the first sending unit.

10. The aircraft data communication system according to claim 8, further comprising:
a second sending unit,
wherein a first group of the plurality of receiving units is allocated to the first sending unit and a second group of the plurality of receiving units is allocated to a second sending unit.

11. The aircraft data communication system according to claim 10,
wherein the aircraft data communication system is adapted to carry out a handover of a receiving unit from the first sending unit to the second sending unit.

12. An aircraft comprising an aircraft data communication system according to claim 1,
wherein the first sending unit is connected to a control unit of an aircraft, and
wherein the aircraft has distributedly mounted a plurality of receiving units.

13. An aircraft comprising an aircraft data communication system according to claims 1,
wherein the first receiving unit is mounted onto a passenger seat.

14. An aircraft comprising an aircraft data communication system according to claim 1,
wherein the first sending unit is mounted onto a cabin panel element or passenger service unit.
